(19) United States
(12) Patent Application Publication
(10) Pub. No.: US 2011/0317163 A1
(43) Pub. Date: Dec. 29, 2011

(54) Method of Aligning a Wafer and Method of Monitoring a Lithography Process Including the Same

(76) Inventors: Seung-Yoon Lee, Seoul (KR); Jeong-Ho Yeo, Suwon-si (KR); Chan Hwang, Seoul (KR)

(21) Appl. No.: 13/166,327

(22) Filed: Jun. 22, 2011

(30) Foreign Application Priority Data
Jun. 28, 2010 (KR) 10-2010-0061331

(51) Int. Cl. G01B 11/14

(52) U.S. Cl. 356/401

(57) ABSTRACT

A method of aligning a wafer includes irradiating light onto a plurality of alignment marks of a wafer, detecting signals outputted from the alignment marks to obtain alignment position offsets, selecting a set of the alignment marks corresponding to the alignment position offsets having a same or similar distribution, and aligning the wafer based the selected alignment marks.

### CROSS-REFERENCE TO RELATED APPLICATION

This application claims priority under 35 U.S.C. §119 to Korean Patent Application No. 2010-61331, filed on Jun. 28, 2010 in the Korean Intellectual Property Office (KIPO), the entire contents of which are herein incorporated by reference.

### BACKGROUND

1. Technical Field

The present disclosure relates to a method of aligning a wafer and a method of monitoring a lithography process including the same, and more particularly to a method of aligning a wafer using diffraction light from alignment marks on the wafer.

2. Description of Related Art

Generally, in lithography processes for manufacturing of semiconductor devices and liquid display devices, an exposure apparatus may be used to transfer a pattern of a mask (or reticle) to a photoresist layer on a substrate such as a wafer.

In order to precisely form the pattern on the wafer during the lithography process, the reticle and the wafer need to be precisely aligned in a defined orientation.

As sequential processes are performed on the wafer, alignment needs to be maintained between successive layers. One method for maintaining alignment is through the use of alignment marks sequentially formed at various positions on the wafer. For example, the wafer may be aligned using an overlay of an alignment mark on the wafer. Further, after exposure and developing processes, the wafer may be aligned using an overlay between an alignment mark formed by a foregoing process and an alignment mark on a photoresist layer formed by a present process.

In a conventional wafer aligning process, diffraction light may be detected from alignment marks formed on the wafer from a foregoing process. However, since the alignment marks include unnecessary signals deviated from a uniform distribution, the detected signals may need to be reviewed and compensated to achieve a precise alignment of the wafer.

### SUMMARY

According to an exemplary embodiment of the present disclosure, a method of aligning a wafer includes irradiating light onto a plurality of alignment marks of a wafer, detecting signals outputted from the alignment marks are detected to obtain alignment position offsets, selecting a set of the alignment marks having the alignment position offsets with a same or similar distribution, and aligning the wafer based on the selected alignment marks.

In exemplary embodiments, the method may further include obtaining the alignment position offsets according to two different wavelengths or two different diffraction orders of the alignment mark.

In exemplary embodiments, irradiating light onto the alignment marks may include irradiating light having different first and second wavelengths onto the alignment marks.

In this case, obtaining the alignment position offsets of the alignment marks may include obtaining a first diffraction image according to the first wavelength, obtaining a second diffraction image according to the second wavelength, and overlapping the first diffraction image and the second diffraction image to obtain the alignment position offsets.

In exemplary embodiments, obtaining the alignment position offsets of the alignment marks may include obtaining a first diffraction image according to a first diffraction order of a diffracted portion of the light, obtaining a second diffraction image according a second diffraction order of a diffracted portion of the light different from the first diffraction order, and overlapping the first diffraction image and the second diffraction image to obtain the alignment position offsets.

In exemplary embodiments, the method may further include forming the alignment marks having a first plurality of patterns extending in a first direction and forming the alignment marks having a second plurality of patterns extending in a second direction.

According to exemplary embodiments, a method of monitoring a lithography process includes forming a plurality of alignment marks of a first wafer, irradiating first light onto the alignment marks of the first wafer, detecting the alignment marks of the first wafer to obtain first alignment position offsets, forming a plurality of alignment marks of a second wafer, irradiating second light onto the alignment marks of the second wafer, detecting the alignment marks of the second wafer to obtain second alignment position offsets, and comparing the first alignment position offsets of the first wafer to the second alignment offsets of the second wafer to monitor a lithography process of the second wafer.

In exemplary embodiments the method may further include obtaining the first alignment position offsets and the second alignment position offsets according to two different wavelengths or two different diffraction orders of the alignment marks.

In exemplary embodiments, the method may further include obtaining data of the first alignment position offsets of the first wafer.

In exemplary embodiments, obtaining the first alignment position offsets of the alignment marks may include obtaining a first diffraction image according to a first wavelength, obtaining a second diffraction image according to a second wavelength different from the first wavelength, and overlapping the first diffraction image and the second diffraction image to obtain the first alignment position offsets.

In exemplary embodiments, obtaining the first alignment position offsets of the alignment marks may include obtaining a first diffraction image according to a first diffraction order of a diffracted portion of the light, obtaining a second diffraction image according a second diffraction order of a diffracted portion of the light different from the first diffraction order, and overlapping the first diffraction image and the second diffraction image to obtain the first alignment position offsets.

In exemplary embodiments, the method may further include obtaining data of the second alignment position offsets of the second wafer.

In exemplary embodiments, obtaining the second alignment position offsets of the alignment marks may include obtaining a first diffraction image according to a first wavelength, obtaining a second diffraction image according to a second wavelength different from the first wavelength, and overlapping the first diffraction image and the second diffraction image to obtain the second alignment position offsets.

In exemplary embodiments, obtaining the second alignment position offsets of the alignment marks may include obtaining a first diffraction image according to a first diffraction order of a diffracted portion of the light, obtaining a second diffraction image according a second diffraction order of a diffracted portion of the light different from the first diffraction order, and overlapping the first diffraction image and the second diffraction image to obtain the second alignment position offsets.

In exemplary embodiments, the method may further include forming the alignment marks having a plurality of patterns extending in a first direction and forming the alignment marks having a second plurality of patterns extending in a second direction.

According to exemplary embodiments, a method of aligning a wafer includes irradiating light onto a plurality of alignment marks of a wafer, detecting a portion of the light diffracted by the alignment marks to obtain alignment position offsets, the diffracted light having two different wavelengths or two different diffraction orders, selecting a set of the alignment marks having the alignment position offsets with a same or similar distribution, and aligning the wafer based on the alignment position offsets of the set of the alignment marks.

According to exemplary embodiments, a method of monitoring a process includes forming a plurality of alignment marks of a first wafer by a first process having first conditions, irradiating first light onto the alignment marks of the first wafer, detecting a portion of the first light diffracted by the alignment marks of the first wafer to obtain first alignment position offsets, forming a plurality of alignment marks of a second wafer by the first process having the first conditions, irradiating second light onto the alignment marks of the second wafer, detecting a portion of the second light diffracted by the alignment marks of the second wafer to obtain second alignment position offsets, and comparing the first alignment position offsets of the first wafer to the second alignment position offsets of the second wafer to determining a distribution change between the first alignment position offsets and the second alignment position offsets.

### BRIEF DESCRIPTION OF THE DRAWINGS

Exemplary embodiments will be more clearly understood from the following detailed description taken in conjunction with the accompanying drawings. FIGS. 1 to 8 represent non-limiting, exemplary embodiments.

FIG. 1 is a flow chart illustrating a method of aligning a wafer in accordance with a first exemplary embodiment.

FIG. 2 is a plan view illustrating a portion of a wafer having alignment marks formed thereon in accordance with a first exemplary embodiment.

FIG. 3 is a cross-section view taken along the line in FIG. 2.

FIG. 4 is a plan view illustrating alignment position offsets according to wavelengths of alignment marks of a photoresist pattern.

FIG. 5 is a plan view illustrating alignment position offsets according to wavelengths of the alignment marks formed by the first process.

FIG. 6 is a plan view illustrating alignment position offsets according to diffraction order of an alignment mark of a photoresist pattern.

FIG. 7 is a plan view illustrating alignment position offsets according to diffraction order of the alignment mark formed by the first process.

FIG. 8 is a flow chart illustrating a method of monitoring a process in accordance with a second exemplary embodiment.

### DETAILED DESCRIPTION OF EXEMPLARY EMBODIMENTS

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough and complete, and will fully convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that tetras, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments will be explained in detail with reference to the accompanying drawings.

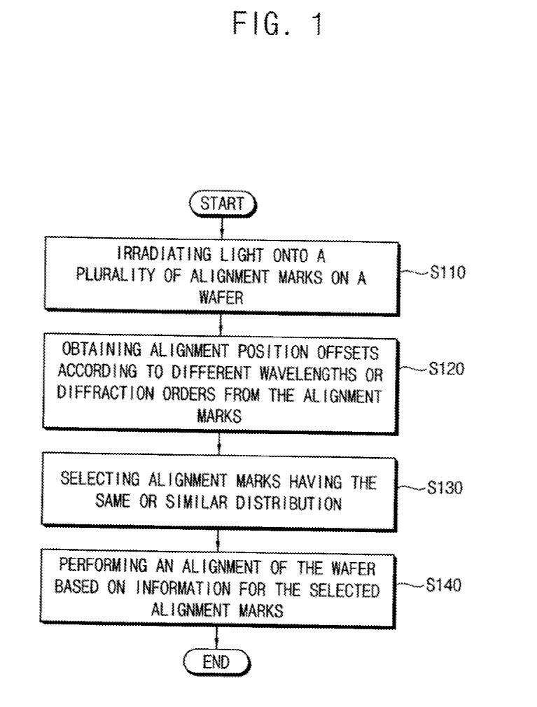

FIG. 1 is a flow chart of a method of aligning a wafer in accordance with a first exemplary embodiment.

Referring to FIG. 1, in a first exemplary embodiment, light may be irradiated onto a plurality of alignment marks on a wafer (S110). When the light strikes the alignment marks, backward diffracted light is collected and analyzed as an alignment signal. A robustness of the marks determines a quality of the alignment signal. The backward diffracted light, or signals, outputted from the alignment marks may be detected to obtain alignment position offsets according to two different wavelengths or two different diffraction orders of the alignment marks (S120). The alignment marks having the same or similar distribution may be selected to inform an alignment of the wafer (S130). The alignment of the wafer may be performed based on information for the selected alignment marks (S140).

In a first exemplary embodiment, an exposure apparatus may be used for aligning the wafer. The exposure apparatus may include an illumination system, a reticle stage, a projection optical system, a wafer stage, a detector and a control unit. For example, the exposure apparatus may be a step-and-scan projection exposure apparatus. This exposure apparatus may be used in a general lithography process, and any further explanations thereof will be omitted.

In a first exemplary embodiment, light may be irradiated onto a plurality of alignment marks on a wafer (S110). The alignment marks may be formed by a first process. Circuit patterns may be formed along with the alignment marks. The alignment marks may be formed in a matrix shape over an entirety of the wafer.

Light may be irradiated onto the alignment marks using the illumination system and the optical system of the exposure apparatus. For example, light having different first and second wavelengths may be irradiated onto the alignment marks. Alternatively, light having single wavelength may be irradiated onto the alignment marks.

Signals outputted from the alignment marks may be detected using the detector of the exposure apparatus, to obtain alignment position offsets according to the different first and second wavelengths or two different diffraction orders of the alignment marks (S120).

When light having the different first and second wavelengths is irradiated onto the alignment marks, the light may be outputted at different diffraction angles. The light having the first wavelength may be reflected from the alignment marks to form a first diffraction image. The light having the second wavelength may be reflected from the alignment marks to form a second diffraction image. The first diffraction image and the second diffraction image may be overlapped to obtain an alignment position offset (alignment color offset) of the alignment mark.

Alternatively, when light having single wavelength is irradiated onto the alignment marks, alignment position offsets according to different diffraction orders may be measured. Diffraction orders may be determined from alignment marks formed by a grating to produce different diffraction patterns when irradiated with light. Measuring a position of the diffraction order of the diffraction patterns produced by the alignment mark may be used to provide information about the position of the alignment mark. For example, an image of fifth-order diffraction light (first diffraction image) and an image of seventh-order diffraction light (second diffraction image) may be obtained from the alignment marks. The first diffraction image and the second diffraction image may be overlapped to obtain an alignment position offset (alignment order offset) according to the different diffraction orders.

Thus, the alignment position offsets may be obtained with respect to the alignment marks over the entire wafer.

The alignment marks having the alignment position offsets of the same or similar distribution may be selected to be used as information for aligning the wafer (S130).

The alignment marks formed by the first process may be formed to have the same or similar structures or different structures over the wafer. Signals outputted from the alignment marks having the same or similar structures may represent the same or similar alignment position offsets. On the other hand, signals outputted from the alignment marks having different structures may represent alignment position offsets largely deviated from the uniform distribution. That is, if the alignment marks have symmetric structures, the detected diffraction lights may be identical in different wavelengths and diffraction orders. Accordingly, the alignment position offsets detected from the alignment marks over the entire wafer may have a specific distribution resulting from the first process.

After the alignment marks having the same or similar distribution are selected by the control unit of the exposure apparatus, a process of aligning the wafer may be performed based on detection information of the selected alignment marks (S140).

Before performing a second process following the first process, the wafer may be aligned based on the detection information of the alignment marks having a uniform distribution. Accordingly, alignment marks having signals deviated from the uniform distribution may be excluded from the detection information. Thus, the wafer may be aligned precisely to substantially prevent overlay errors from occurring between the first process and the second process.

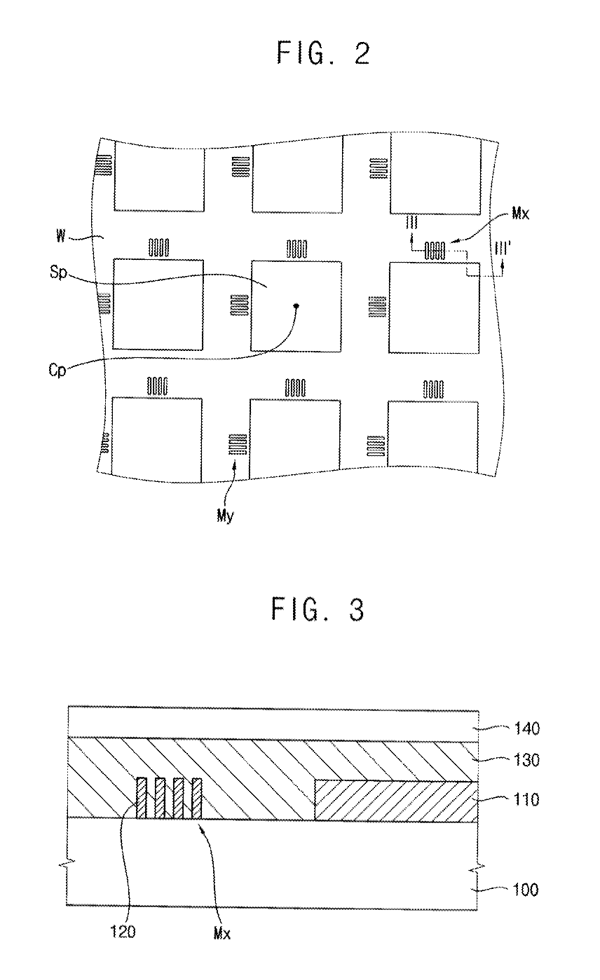

FIG. 2 is a plan view illustrating a portion of a wafer having alignment marks foimed thereon in accordance with a first exemplary embodiment. FIG. 3 is a cross-section view taken along the line III-III′ in FIG. 2.

Referring to FIGS. 2 and 3, a plurality of alignment marks (Mx, My) is formed on a wafer (W).

In a first exemplary embodiment, the wafer (W) may include a plurality of shot regions (Sp) where circuit patterns are formed. The shot regions (Sp) may be divided by a plurality of scribe lines crossing each other perpendicularly.

The circuit patterns 110 may be formed along with the alignment marks (Mx, My) on the wafer (W) by performing a first process. For example, a wafer X mark (Mx) may be fabricated to represent an X coordinate of the center (Cp) of each shot region and a wafer Y mark (My) may be fabricated to represent a Y coordinate of the center (Cp) of each shot region. That is, the center (Cp) position of each shot region may be represented by a respective X coordinate of the wafer X mark (Mx) and a respective Y coordinate of the wafer Y mark (My).

In this case, the wafer X mark (Mx) may include first patterns 120 that are Ruined repeatedly in X direction and the wafer Y mark (My) may include second patterns that are formed repeatedly in Y direction. The wafer X mark (Mx) and the wafer Y mark (My) may be line and space marks extending in a direction. The alignment marks may have a pitch of about 200 nm to about 2 μm. For example, the pitch of the alignment marks may be about 2 μm. In this embodiment, the first patterns 120 of four lines may be used as the wafer X mark (Mx), however, the number of the line patterns is not limited thereto.

As illustrated in FIG. 3, the circuit pattern 110 and the alignment marks (Mx, My) of the first pattern 120 may be formed on a semiconductor substrate 100 such as the wafer (W). An upper layer 130 and a photoresist layer 140 may be sequentially formed on the circuit pattern 110 and the first pattern 120. The photoresist layer 140 may be used for pattering the upper layer 130.

The circuit pattern 110 may be formed using a conductive material. The alignment marks (Mx, My) may be formed using an insulating material. The upper layer 130 may include a conductive material or an insulating material. The circuit pattern 110 and the upper layer 130 may be formed by a deposition process such as a chemical vapor deposition process, a physical vapor deposition process or an atomic layer deposition process.

In a first exemplary embodiment, before performing a second process for pattering the upper layer 130, the wafer (W) may be aligned using the alignment marks (Mx, My).

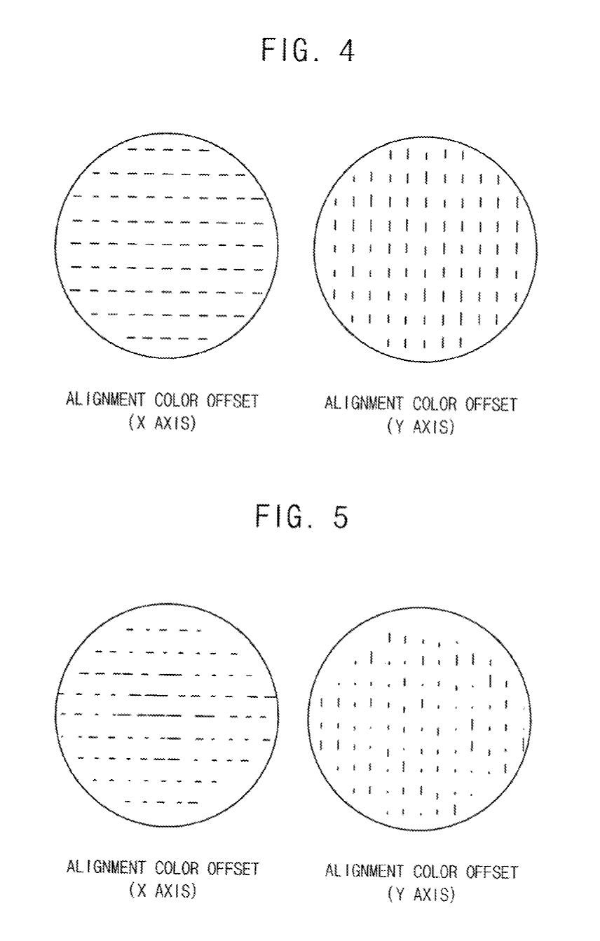

FIG. 4 is a plan view illustrating alignment position offsets (alignment color offsets) according to wavelengths of backward diffracted light from alignment marks of a photoresist pattern. FIG. 5 is a plan view illustrating alignment position offsets according to wavelengths of backward diffracted light from the alignment marks formed by the first process.

Referring to FIG. 4, alignment marks may be formed using a photoresist pattern on a wafer (W). In this case, the photoresist pattern may be formed on the wafer (W) to be used as the alignment mark. Accordingly, the alignment marks of the photoresist pattern may have reference alignment position offsets.

When light having different first and second wavelengths is irradiated onto the alignment marks, the light may be outputted at different diffraction angles. For example, the light having the first wavelength may be red light and the light having the second wavelength may be green light.

The light having the first wavelength may be reflected from the alignment marks to form a first diffraction image. The light having the second wavelength may be reflected from the alignment marks to form a second diffraction image. The first diffraction image and the second diffraction image may be overlapped to obtain an alignment position offset according to different wavelengths of the alignment mark. The alignment position offsets of the different wavelengths may be obtained from the diffraction light reflected from the alignment marks, to represent a position difference at the respective alignment mark.

The following descriptions refer to a three-sigma rule (3σ), wherein for a normal distribution, almost all of a population lies within three standard deviations of the mean. For the normal distribution about 99.73% of the population lies within three standard deviations of the mean.

As illustrated in FIG. 4, the alignment color offsets (X axis) have 3σ of about 1.3 and an average of about −3.0. The alignment color offsets (Y axis) have 3σ of about 1.3 and an average of about 2.97. Accordingly, the alignment marks may have a uniform distribution over the entire wafer (W). That is, the alignment marks may be formed to have the same or similar structures over the wafer (W).

Referring to FIG. 5, alignment marks may be formed using an insulating material. In this case, the alignment marks may be formed along with circuit patterns on the wafer (W) by the first process.

When light having different first and second wavelengths is irradiated onto the alignment marks, the light may be outputted at different diffraction angles. For example, the light having the first wavelength may be red light and the light having the second wavelength may be green light.

The light having the first wavelength may be reflected from the alignment marks to form a first diffraction image. The light having the second wavelength may be reflected from the alignment marks to form a second diffraction image. The first diffraction image and the second diffraction image may be overlapped to obtain an alignment position offset (alignment color offset) according to the first and second wavelengths of the alignment marks.

As illustrated in FIG. 5, the alignment color offsets (X axis) have 3σ of about 7.8 and an average of about −0.41. The alignment color offsets (Y axis) have 3σ of about 5.8 and an average of about 1.30. Accordingly, the alignment marks may have an uneven distribution over the entire wafer (W). That is, the alignment marks may be formed to have different structures over the wafer (W).

In a first exemplary embodiment, only the alignment marks having the same or similar alignment position offsets may be selected for aligning the wafer. For example, the alignment position offsets of the selected alignment marks may be within a predetermined deviation range. The deviation range may be determined based on standard deviations of the total offsets in order to represent the alignment marks having the same or similar alignment position offsets. Then, a process of aligning the wafer may be performed based on detection information of the selected alignment marks.

Accordingly, alignment marks having signals deviated from a uniform distribution may be excluded from the detection information. Thus, the wafer may be aligned precisely to prevent overlay errors from occurring between the first process and the second process.

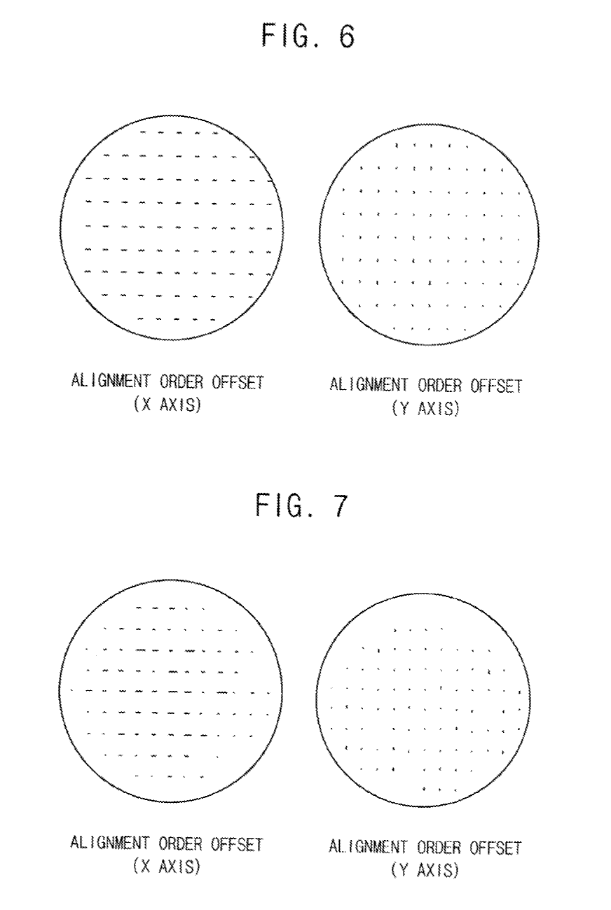

FIG. 6 is a plan view illustrating alignment position offsets according to diffraction order of an alignment mark of a photoresist pattern. FIG. 7 is a plan view illustrating alignment position offsets according to diffraction order of the alignment mark formed by the first process.

Referring to FIG. 6, alignment marks may be formed using a photoresist pattern on a wafer (W). In this case, the photoresist pattern may be formed on the wafer (W) to be used as the alignment mark. Accordingly, the alignment marks of the photoresist pattern may have reference alignment position offsets.

After light is irradiated onto the alignment marks, alignment position offsets according to different diffraction orders may be measured. For example, after red light (633 nm) is irradiated onto the alignment marks, an image of fifth-order diffraction light (first diffraction image) and an image of seventh-order diffraction light (second diffraction image) may be obtained.

The first diffraction image and the second diffraction image may be overlapped to obtain an alignment position offset (alignment order offset) according to different diffraction orders of the alignment mark. The alignment position offsets according to the diffraction orders may be obtained from diffracted light reflected from a diffraction grating of the alignment marks, to represent a position difference at the respective alignment mark. The diffraction grating produces first and second diffracted images of different diffraction orders or of the same diffraction order but of different signs.

As illustrated in FIG. 6, the alignment order offsets (X axis) have 36 of about 2.0 and an average of about 6.9. The alignment color offsets (Y axis) have 36 of about 1.5 and an average of about −3.57. Accordingly, the alignment marks may have a uniform distribution over the entire wafer (W). That is, the alignment marks may be formed to have the same or similar structures over the wafer (W).

Referring to FIG. 7, alignment marks may be formed using an insulating material. In this case, the alignment marks may be formed along with circuit patterns on the wafer (W) by the first process.

After light is irradiated onto the alignment marks, alignment position offsets according to different diffraction orders may be measured. For example, after red light (633 nm) is irradiated onto the alignment marks, an image of fifth-order diffraction light (first diffraction image) and an image of seventh-order diffraction light (second diffraction image) may be obtained.

The first diffraction image and the second diffraction image may be overlapped to obtain an alignment position offset (alignment order offset) according to different diffraction orders of the alignment mark. The alignment position offsets according to diffraction orders may be obtained from different orders diffraction lights reflected from the alignment marks, to represent a position difference at the respective alignment mark.

As illustrated in FIG. 7, the alignment color offsets (X axis) have 3σ of about 9.6 and an average of about 3.9. The alignment color offsets (Y axis) have 3σ of about 7.4 and an average of about 0.02. Accordingly, the alignment marks may have an uneven distribution over the entire wafer (W). That is, the alignment marks may be formed to have different structures over the wafer (W).

In a first exemplary embodiment, only the alignment marks having the same or similar alignment order offsets may be selected for aligning the wafer. A process of aligning the wafer may be performed based on detection information of the selected alignment marks.

Accordingly, alignment marks having signals deviated from the uniform distribution may be excluded from detection information. Thus, the wafer may be aligned precisely to substantially prevent overlay errors from occurring between the first process and the second process.

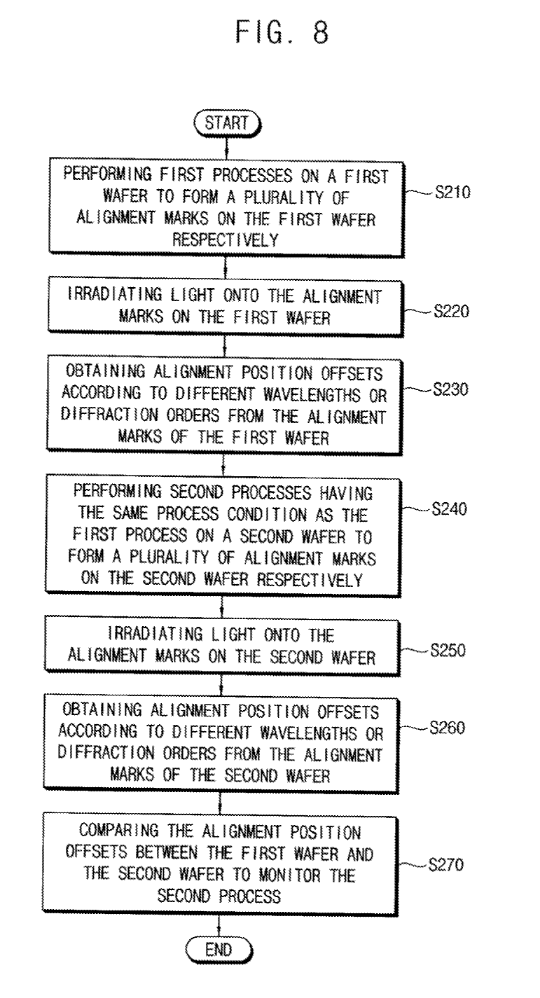

FIG. 8 is a flow chart illustrating a method of monitoring a process in accordance with a second exemplary embodiment. The process monitoring method may be performed using alignment position offsets of alignment marks described herein.

Referring to FIG. 8, in a second exemplary embodiment, a first process may be performed on at least one first wafer to form a plurality of alignment marks on the at least one first wafer (S210). Light may be irradiated onto the alignment marks on the at least one first wafer (S220). Backward diffracted light, or signals, outputted from the alignment marks on the first wafer may be detected to obtain alignment position offsets according to two different wavelengths or two different diffraction orders of the alignment marks of the first wafer (S230). A second process having the same process condition(s) as the first process may be performed on at least one second wafer to form a plurality of alignment marks on the second wafer (S240). Light may be irradiated onto the alignment marks on the second wafer (S250). Backward diffracted light, or signals, outputted from the alignment marks on the second wafer may be detected to obtain alignment position offsets according to two different wavelengths or two different diffraction orders of the alignment marks of the second wafer (S260). The alignment position offsets between the first wafer and the second wafer may be compared to monitor the second process (S270).

In a second exemplary embodiment, the exposure apparatus described herein may be used for aligning the wafer. This exposure apparatus may be used in a general lithography process, and any further explanations thereof will be omitted.

In a second exemplary embodiment, the first process may be performed on the first wafer to form the alignment marks on the first wafer (S210). The first process may be performed simultaneously or sequentially on one or more first wafers and is substantially the same for each of the first wafers. Here, the wafers on which the same process is performed may be referred to as the first wafers.

The alignment marks may be formed on the first wafer by performing the first process. Circuit patterns may be formed along with the alignment marks by the first process. The alignment marks may be formed in a matrix shape over the entirety of the first wafer.

Light may be irradiated onto the alignment marks of the first wafer using the illumination system and the optical system of the exposure apparatus. For example, light having different first and second wavelengths may be irradiated onto the alignment marks. Alternatively, light having single wavelength may be irradiated onto the alignment marks.

Signals outputted from the alignment marks may be detected using the detector of the exposure apparatus, to obtain alignment position offsets according to the different first and second wavelengths or two different diffraction orders of the alignment marks of the first wafer (S230).

When light having the different first and second wavelengths is irradiated onto the alignment marks, the light may be outputted at different diffraction angles. The light having the first wavelength may be reflected from the alignment marks to form a first diffraction image. The light having the second wavelength may be reflected from the alignment marks to form a second diffraction image. The first diffraction image and the second diffraction image may be overlapped to obtain an alignment position offset (alignment color offset) of the alignment mark.

Alternatively, when light having single wavelength is irradiated onto the alignment marks, alignment position offsets according to different diffraction orders may be measured. For example, an image of fifth-order diffraction light (first diffraction image) and an image of seventh-order diffraction light (second diffraction image) may be obtained from the alignment marks. The first diffraction image and the second diffraction image may be overlapped to obtain an alignment position offset (alignment order offset) according to the different diffraction orders.

In a second exemplary embodiment, first alignment position offsets of the first wafers may be stored. Having determined and/or stored the first alignment position offsets, data of distributions for the alignment position offsets of each of the first wafers may be obtained. The data may serve as an identifier for the first wafer on which the first process is performed.

The second process having the same process condition as the first process may be performed on at least one second wafer to form the alignment marks on the second wafer (S240). Similarly to steps S220 and 5230, light may be irradiated onto the alignment marks on the second wafer (S250) and signals outputted from the alignment marks on the second wafer may be detected to obtain alignment position offsets according to two different wavelengths or two different diffraction orders of the alignment marks of the second wafer (S260). Accordingly, second alignment position offsets of the second wafers may be obtained.

In a second exemplary embodiment, the first alignment position offsets of the first wafer and the second alignment position offsets of the second wafer may be compared to determine whether the second process has been performed correctly (S270). For example, if the distribution tendencies of the first alignment position offsets and the second alignment position offsets are different from each other, it may be determined that the second process has been performed in a different manner from the first process.

Accordingly, the distribution change of the first alignment position offsets obtained after the first process and the second alignment position offsets obtained after second process following the first process may be detected to thereby to monitor the second process.

As described herein, in a method of aligning a wafer, alignment position offsets according to two different wavelengths or two different diffraction orders of the alignment marks may be obtain from alignment marks. The alignment marks having the same or similar distribution may be selected, and an alignment of the wafer may be performed based on information for the selected alignment marks.

Accordingly, even though some of alignment marks are formed having a deformation or defect due to an abnormality of a foregoing process, alignment marks having signals deviated from the uniform distribution may be excluded from detection information to be used to align the wafer. Thus, the wafer may be aligned precisely to substantially prevent overlay errors from occurring after performing a following process. Further, the alignment of the wafer may be linearity-corrected using information of only the selected alignment marks, e.g., the alignment marks having the same or similar alignment position offsets.

According to exemplary embodiments, in a method of monitoring a lithography process, first alignment position offsets according to two different wavelengths or two different diffraction orders may be obtained from alignment marks of at least one first wafer. Second alignment position offsets according to two different wavelengths or two different diffraction orders may be obtained from alignment marks of at least one second wafer where a second process having the same conditions as the first process is performed. The first and second alignment position offsets may be compared to monitor the second process.

Accordingly, the distribution change of the first alignment position offsets and the second alignment position offsets obtained after may be detected to thereby to monitor the second process.

The foregoing is illustrative of exemplary embodiments and is not to be construed as limiting thereof. Although a few exemplary embodiments have been described, those skilled in the art will readily appreciate that many modifications are possible in exemplary embodiments without materially departing from the novel teachings and advantages of the present invention. Accordingly, all such modifications are intended to be included within the scope of exemplary embodiments as defined in the claims. In the claims, means-plus-function clauses are intended to cover the structures described herein as performing the recited function and not only structural equivalents but also equivalent structures. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A method comprising:
irradiating light onto a plurality of alignment marks of a wafer;
detecting signals outputted from the alignment marks to obtain alignment position offsets;
selecting a set of the alignment marks having the alignment position offsets with a same or similar distribution; and
aligning the wafer based on the set alignment marks.

2. The method of claim 1, further comprising obtaining the alignment position offsets according to two different wavelengths or two different diffraction orders of the alignment marks.

3. The method of claim 1, wherein irradiating light onto the alignment marks comprises irradiating light having different first and second wavelengths onto the alignment marks.

4. The method of claim 3, wherein obtaining the alignment position offsets of the alignment marks comprises:
obtaining a first diffraction image according to the first wavelength;
obtaining a second diffraction image according to the second wavelength; and
overlapping the first diffraction image and the second diffraction image to obtain the alignment position offsets.

5. The method of claim 1, wherein obtaining the alignment position offsets of the alignment marks comprises:
obtaining a first diffraction image according to a first diffraction order of a diffracted portion of the light;
obtaining a second diffraction image according a second diffraction order of a diffracted portion of the light different from the first diffraction order; and
overlapping the first diffraction image and the second diffraction image to obtain the alignment position offsets.

6. The method of claim 1, further comprising forming the alignment marks having a first plurality of patterns extending in a first direction.

7. The method of claim 1, further comprising forming the alignment marks having a second plurality of patterns extending in a second direction.

8. A method comprising:
foaming a plurality of alignment marks of a first wafer;
irradiating first light onto the alignment marks of the first wafer;
detecting the alignment marks of the first wafer to obtain first alignment position offsets;
forming a plurality of alignment marks of a second wafer;
irradiating second light onto the alignment marks of the second wafer;
detecting the alignment marks of the second wafer to obtain second alignment position offsets; and
comparing the first alignment position offsets of the first wafer to the second alignment position offsets of the second wafer to monitor a lithography process of the second wafer.

9. The method of claim 8, further comprising obtaining the first alignment position offsets and the second alignment position offsets according to two different wavelengths or two different diffraction orders of the alignment marks.

10. The method of claim 8, further comprising obtaining data of the first alignment position offsets of the first wafer.

11. The method of claim 8, wherein obtaining the first alignment position offsets of the alignment marks comprises:
obtaining a first diffraction image according to a first wavelength;
obtaining a second diffraction image according to a second wavelength different from the first wavelength; and
overlapping the first diffraction image and the second diffraction image to obtain the first alignment position offsets.

12. The method of claim 8, wherein obtaining the first alignment position offsets of the alignment marks comprises:
obtaining a first diffraction image according to a first diffraction order of a diffracted portion of the light;
obtaining a second diffraction image according a second diffraction order of a diffracted portion of the light different from the first diffraction order; and
overlapping the first diffraction image and the second diffraction image to obtain the first alignment position offsets.

13. The method of claim 8, further comprising obtaining data of the second alignment position offsets of the second wafer.

14. The method of claim 8, wherein obtaining the first alignment position offsets of the alignment marks comprises:
obtaining a first diffraction image according to a first wavelength;
obtaining a second diffraction image according to a second wavelength different from the first wavelength; and
overlapping the first diffraction image and the second diffraction image to obtain the second alignment position offsets

15. The method of claim 8, wherein obtaining the second alignment position offsets of the alignment marks comprises:
obtaining a first diffraction image according to a first diffraction order of a diffracted portion of the light;
obtaining a second diffraction image according a second diffraction order of a diffracted portion of the light different from the first diffraction order; and
overlapping the first diffraction image and the second diffraction image to obtain the second alignment position offsets.

16. The method of claim 8, further comprising forming the alignment marks having a plurality of patterns extending in a first direction.

17. The method of claim 8, further comprising forming the alignment marks having a second plurality of patterns extending in a second direction.

18. A method comprising:
irradiating light onto a plurality of alignment marks of a wafer;
detecting a portion of the light diffracted by the alignment marks to obtain alignment position offsets, the diffracted light having two different wavelengths or two different diffraction orders;
selecting a set of the alignment marks having the alignment position offsets with a same or similar distribution; and
aligning the wafer based on the alignment position offsets of the set of the alignment marks.

19. A method comprising:
forming a plurality of alignment marks of a first wafer by a first process having first conditions;
irradiating first light onto the alignment marks of the first wafer;
detecting a portion of the first light diffracted by the alignment marks of the first wafer to obtain first alignment position offsets;
forming a plurality of alignment marks of a second wafer by the first process having the first conditions;
irradiating second light onto the alignment marks of the second wafer;
detecting a portion of the second light diffracted by the alignment marks of the second wafer to obtain second alignment position offsets; and
comparing the first alignment position offsets of the first wafer to the second alignment position offsets of the second wafer to determining a distribution change between the first alignment position offsets and the second alignment position offsets.
